(19) United States
(12) Patent Application Publication
(10) Pub. No.: US 2015/0099239 A1
(43) Pub. Date: Apr. 9, 2015

(54) ENDOSSEOUS IMPLANT AND METHOD FOR PRODUCTION THEREOF

(71) Applicant: ZDA-ZIRCONIA DEVELOPPEMENT & APPLICATIONS, LAVAL CEDEX (FR)

(72) Inventors: JEANNINE GOURLAOUEN-PREISSLER, MONTREUIL (FR); BERTRAND BUSSON, PARIS (FR)

(21) Appl. No.: 14/571,094

(22) Filed: Dec. 15, 2014

Related U.S. Application Data
(63) Continuation-in-part of application No. 13/512,410, filed on Sep. 24, 2012, now abandoned.

(30) Foreign Application Priority Data
Nov. 27, 2009 (FR) 0958461
Dec. 21, 2009 (FR) 0959327
Nov. 22, 2010 (FR) 1059598

(51) Int. Cl. A61C 8/00

(52) U.S. Cl. CPC A61C 8/0024; A61C 8/0012; A61C 8/0037; A61C 2008/0046
USPC 433/174; 433/173

(57) ABSTRACT

An endosseous implant for an implantation in a periodontal tissue made of a sintered ceramic material. The first surface of the implant is configured to be implanted in an alveolar bone tissue. The first surface texture has patterns of recessed alveolar cavities with a closed outline whose average width lies between 8 μm and 15 μm and a surface finish lying between 1 μm and 3 μm. The second surface of the implant is configured to be implanted in a cortical bone tissue. The second surface texture has a pattern of recessed alveolar cavities with a closed outline whose width lies between 1.5 μm and 5 μm and a surface finish lying between 0.1 μm and 0.5 μm. The first and second textures replicate surface texture of tissues similar to the implantation alveolar bone tissue and implantation cortical bone tissue, respectively.

### RELATED APPLICATIONS

This application is a continuation-in-part of co-pending U.S. application Ser. No. 13/512,410 filed Sep. 24, 2012, which is a §371 application from PCT/EP2010/068431 filed Nov. 29, 2010, which claims priority from French Patent Application No. 0958461 filed Nov. 27, 2009, French Application No. 0959327 filed Dec. 21, 2009 and French Application No. 1059598 filed Nov. 22, 2010, each of which is herein incorporated by reference in its entirety.

### TECHNICAL FIELD OF THE INVENTION

The invention relates to an endosseous implant made of ceramics for medical or veterinary applications. More particularly the invention relates to such a nonmetal implant, preferentially made of a ceramic material.

### BACKGROUND OF THE INVENTION

Endosseous implants known from prior art, in particular those for a periodontal implantation, consist of metallic materials, generally containing titanium. These prior art implants are subjected to various surface treatments aiming at conferring a surface finish promoting their osseointegration after implantation in the bone tissue. These surface finishes are obtained either by coating the implant, or a zone of this implant, in particular by projection, with a layer of a material exhibiting a surface texture and physicochemical characteristics promoting cell colonization by osteoblasts of the surface thus coated. Alternatively, such a surface finish can be obtained by machining, i.e. by material removal, of the whole or part of surface of said implant, for example, by machining with a cutting tool, a laser or by abrasion by using sanding or shot-blasting techniques.

In addition to the fact that the techniques using material removal are hardly applicable to an implant made of a very hard ceramic material, in particular because of the lack of ductility of such a material which does not allow the formation of a chip by plastic flow of the material; the surface texture is very dependent on the nature of the process and on the material-process couple. Thus, the optimization of the surface finish conditions is performed through experimental designs and clinical trials aiming, for example, at correlating characteristic features of the surface thus obtained, with the rate of osseointegration of the implant comprising such a surface. These trials are long lasting, expensive and once the conditions appearing to be optimal are obtained, it still remains to determine the parameters of the surface treatment to control so that the result is reproducible within the framework of a production, more particularly in mass production.

Document US 2009/0035723 discloses a method for machining a texture on the surface of an implant by laser machining. This method is suitable for the machining of a metallic material that exhibits plastic behavior. Using such a laser ablation on a ceramic material is, first of all, difficult because of the high temperature resistance of the ceramic material, and furthermore might result in micro cracks formation under the machined surface. This method is expensive and not suitable for a mass production.

### OBJECT AND SUMMARY OF THE INVENTION

In order to solve the disadvantages of prior art, the invention proposes an endosseous implant, in particular for an implantation in a periodontal tissue remarkable in that:

a. it is made of a sintered ceramic material;

b. it comprises a surface suitable for being implanted in a recipient tissue and that said surface includes a raised texture, made of patterns with a closed outline said texture is analogous to the texture of the surface of the recipient tissue, and said pattern is printed of the surface by molding before sintering.

In all of the text, a surface texture indicates the form of a raised pattern of a surface designated as S-L according to the ISO 25178 standard which is here incorporated by reference, i.e., raised patterns whose order of magnitude is within the roughness parameters and waviness of a surface of any macroscopic form, virtually reduced to a flat surface by a filter according to the ISO16610 standard which is here incorporated by reference. A surface finish qualifies such a surface by a parameter according to the ISO 25178 standard.

The term “analogous” shall be here understood in the sense that the surface texture of the implant reproduces a network of substantially homothetic geometrical patterns, the geometry and the dimensions of these patterns being comparable with the patterns of the surface texture of the recipient tissue, without being, strictly speaking, identical thereto.

Thus, the implant according to the invention reproduces not only the surface finish of the implantation tissue but exhibits texture patterns whose form and dimension are adapted to the recipient tissue, which promotes the cell colonization of said implant surface by the recipient tissue, while, being of a closed outline, this texture does not constitute an easy pass for the bacteria to penetrate from outside into the implantation well, once the implant is set up. This result is obtained in a reproducible way and in mass production through, in particular, the nature of the implant, made of a sintered ceramic. For this purpose, the invention also relates to a manufacturing method for such an implant, said method comprising the steps consisting in:
a. etching on the wall of the imprint of a mould, a network of patterns forming a surface texture, the dimensions of the said patterns taking into account of the shrinking of the ceramic constituting the implant during sintering;
b. injecting a ceramic powder mixed with a binder in said mould so as to obtain a rough shape of the part in the green state;
c. sintering said rough part so as to obtain the finished part.

Thus the method according to the invention takes advantage from the very important shrinkage observed during the sintering of the ceramic and makes it possible to etch the mould with a much larger pattern in dimensions, than it will be on the sintered implant, thus opening the possibility of using etching technologies which would not be usable at the scale of the patterns seen on the implant. In addition, the mould can advantageously be made of a metallic material which exhibits a ductile response to the material removal, thus authorizing the use of etching techniques which could not be used on the ceramic implant itself.

The invention can be implemented according to the advantageous embodiments exposed hereafter, that can be considered individually or according to any technically effective combination.

Advantageously, the method according to the invention comprises moreover the steps consisting in:

d. obtaining an image of the surface texture of the surface of a tissue similar to that in which the implant shall be implanted;

e. applying to this image a scale factor according to the shrinkage during the sintering of the ceramic constituting the implant;

f. etching the aforementioned image scaled according to this factor on a wall of the imprint of a mould.

Thus the surface texture reproduced on the implant is the nearest as possible to that of the recipient tissue.

The “similar” term is, in this text, equivalent to “compared to” i.e. it stands, in this context, as the image of a tissue of the same category but not belonging necessarily to the same patient or to the same animal than the tissue in which the implant is set up.

According to a first embodiment of the implant according to the invention, it comprises a surface suitable for being implanted in an alveolar bone tissue said surface including a texture consisting in an alveolar geometry patterns whose average width lies between 8 μm and 15 μm. Thus, the alveolar cavities are colonized by the osseous cells of the tissue after implantation, and the surface relief ensures a mechanical fixing of the implant in the alveolar bone by osseointegration. Contrary to a machining groove, which frequently constitutes the surface texture pattern of a machined metallic implant, each alveolar cavity of the implantation surface cooperating with the recipient tissue constitutes a closed microvolume without direct communication with the neighboring texture patterns. Thus, the surface texture of the implant does not constitute an easy way allowing bacteria, following the surface of the implant, to be introduced deeply into the recipient tissue. Each of these closed microvolumes constitutes individually a potential anchoring of the implant in the recipient tissue.

In all text 1 μm is equal to 10⁻⁶ meters.

Advantageously also, the surface finish Sz of the surface texture of the surface suitable for being implanted in the alveolar bone tissue lies between 1 μm and 3 μm. Sz parameter is defined according to ISO 25178 standard as de height difference between the deepest valley and the tallest crest of a surface sample, whose dimension is defined according to the standard and known as the evaluation surface, once the mean shape of the evaluation surface has been brought to flat through a gaussian filtering according to ISO 16610 known as L filter in ISO 25178. This value of the surface finish, which corresponds roughly to the maximum depth of the alveolar cavities of the texture, is optimal for the cell colonization in this type of tissue and for the osseointegration of the implant in thereto.

The width and depth combination of the alveolar cavity is thus adapted to the mechanical characteristics of the recipient tissue so as to fulfill the mechanical anchoring function.

According to particularly advantageous an embodiment of this first variant, the surface suitable for being implanted in the alveolar bone tissue includes a texture reproducing the surface texture of a tissue similar to that of the implantation. Thus the surface texture is the closest to the texture of the tissue in which the implant according to the invention is implanted.

According to a second embodiment of the implant according to the invention, this one comprises a surface suitable for being implanted in a cortical bone tissue, said surface including a texture consisting in a pattern of an alveolar geometry whose average width lies between 1.5 μm and 5 μm. Thus, in addition to the effect of promoting the osseointegration of the surface in the tissue, this surface relief ensures a strong mechanical fixing of the implant in the cortical bone after osseointegration, and consequently the mechanical stability of this one.

Advantageously also, the surface finish Sz of the surface texture of the surface suitable for being implanted in the cortical bone tissue lies between 0.1 μm and 0.5 μm. Thus the thickness of the osseointegration layer in the harder cortical bone, is lower than in the vascularized and more plastic alveolar bone. This reduced thickness makes it possible to better distribute the incompatibilities of elastic strain between the ceramic implant, whose elastic module is definitely higher than that of the bone tissue, and the cortical bone, while ensuring a mechanical anchoring of this one in the bone.

Advantageously the surface suitable for being implanted in the cortical bone tissue includes a texture replicating the surface texture of a tissue similar to that of the implantation tissue. Thus the osseointegration capacity is optimal.

In a third embodiment, the implant according to invention includes a surface adapted to be implanted in a soft connective tissue, in particular a gum tissue, said surface having a texture replicating the surface texture of a tissue similar to the implantation tissue. This surface texture promotes the regeneration of the soft connective tissue on the implant and thus the sealing of the osseous implantation of the aforesaid implant.

According to a particularly advantageous embodiment, the implant of the invention extends in a longitudinal direction and comprises a succession of longitudinal surfaces with different surface textures replicating textures similar to those tissues with which they come into contact during the in vivo implantation of said implant. This embodiment allows an optimal anchoring of the implant over all its length of tissue implantation.

Advantageously, the implant of the invention according to its first embodiment comprises a cylindrical body and the surface implantable in the alveolar bone is a threading comprising a cutting edge extending parallel to the cylinder axis so that said threading is self-tapping in the alveolar bone tissue. Thus, the cutting of the bone tissue by the cutting edge during the introduction of the implant into the aforementioned tissue, promotes, through a compaction effect, the intimate contact of this tissue with the sides of the threading: an advantageous way for the sealing of the implantation and the osseointegration of the implant surface.

According to an advantageous embodiment of the second variant of the implant of the invention, this one comprises an appreciably cylindrical body and the implantable surface in the cortical bone comprises a conical threading comprising at least one thread. This conical threading ensures a primary mechanical anchoring of the implant in the hard cortical bone.

Advantageously, the conicity of the threading of the implantable surface in the cortical bone lies between 0.02 and 0.1. This low conicity makes it possible to ensure a radial maintaining of the implant over all its implantation length in the cortical bone.

Advantageously, the thread of the cone-shaped threading is interrupted at each turn. This provision prevents bacteria, following the surface of the thread, of penetrating deeply in the tissue implantation.

Advantageously, the thread interruption surface comprises a cutting edge. Thus, the part of the implant implantable in the cortical bone is self-tapping, taking advantage of the ceramic nature, thus very hard, of the implant.

### BRIEF DESCRIPTION OF THE DRAWINGS

The invention will be more specifically described by its preferred, thus non limiting, embodiments, outlined below and in FIGS. 1 to 6, in which:

FIG. 1A represents an implant body, according to an exemplary embodiment of the invention seen in perspective from the front;

FIG. 1B shows a detail view identified as Z1 on FIG. 1A;

FIG. 1C shows a detail view identified as Z2 on FIG. 1A;

FIG. 2 shows in perspective in section seen from the front, an implant according to an exemplary embodiment of the invention in a mandibular implantation;

FIG. 3 is a front view and highly magnified section of the contact between the textured surface of an implant according to an exemplary embodiment of the invention, and a recipient bone tissue;

FIG. 4 represents according to a front view in perspective an exemplary embodiment of a healing collar adaptable on an implant according to the invention;

FIG. 5 is a perspective view seen from the bottom of an exemplary embodiment of an abutment adaptable on an implant according to the invention; and

FIG. 6 is a flowchart describing the sequence of steps according to an exemplary embodiment of the method according to the invention.

### DETAILED DESCRIPTION OF THE EMBODIMENTS

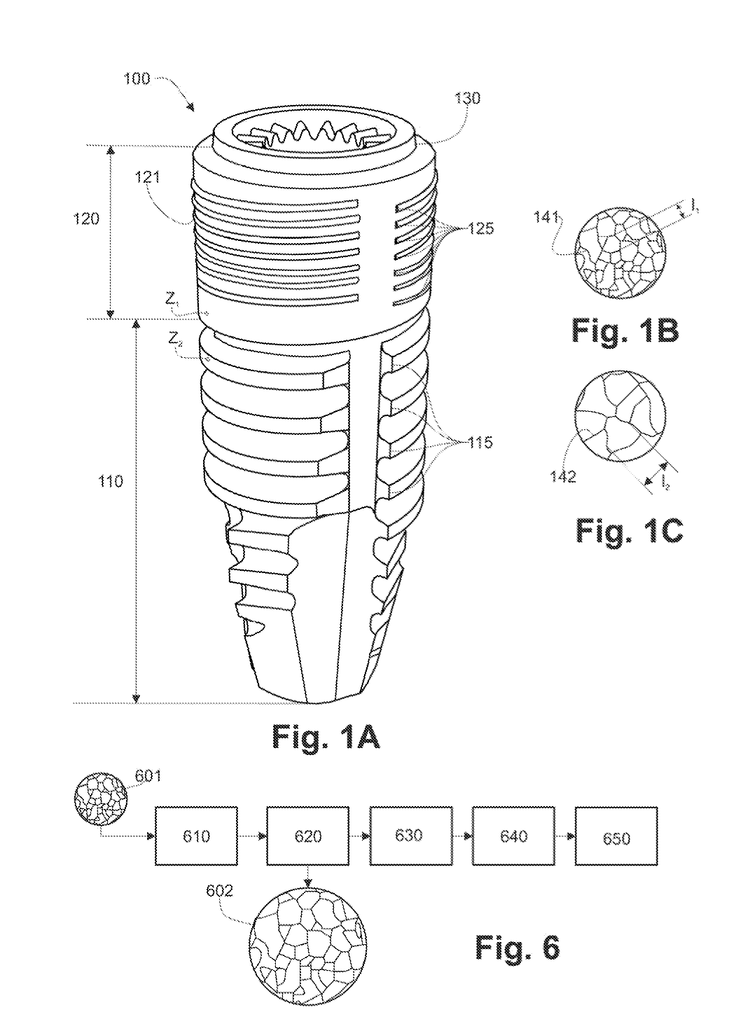

FIG. 1, according to an example embodiment of an implant (100) according of the invention, more particularly suitable for a periodontal implantation, this one comprises an appreciably cylindrical body, whose surface in contact with the recipients tissues comprises three longitudinal sections.

A first section (110) suitable for an implantation in the alveolar bone, comprises a threading with a broad pitch. This threading is interrupted at each turn and each interruption of this thread defines a cutting edge (115). A second section (120) suitable for an implantation in the cortical bone comprises a cone-shaped micro-threading (121), said micro-threading being also interrupted at each turn, each interruption constituting a cutting edge (125). Finally, a third section (130) suitable for being implanted in the gum.

As seen in FIG. 1C, the surface of the first section (110), further designated as the first surface, comprises a surface texture consisting of alveolar cavities (142) with a closed outline whose width L2 lies between 8 μm and 15 μm.

FIG. 1C, the contours of the alveolar cavities (142) of the first surface are points reliefs protruding from the surface (110) of the implant, the inside of the cavities (142) being recessed. The depth of the alveolar cavities lies between 1 μm and 3 μm, so that the surface finish Sz of this surface (110) appreciably lies between these values.

As seen on FIG. 1B the surface of the second section (120), further designated as the second surface, comprises a surface texture consisting of alveolar cavities (141) with a closed outline whose width L1 lies between 1.5 μm and 5 μm for a depth ranging between 0.1 μm and 0.5 μm. As for the first surface in the first section (110), the contour of the alveolar cavities is protruding and the interior of the alveolar cavities (141) is recessed.

The implant (100) is made out of ceramic, preferentially of zirconium dioxide (ZrO2), usually called zirconia, and more particularly of quadratic zirconia (ZrO2/Y2O3) stabilized with yttrium oxide, this last composition offering an optimal resistance to bending and cracking.

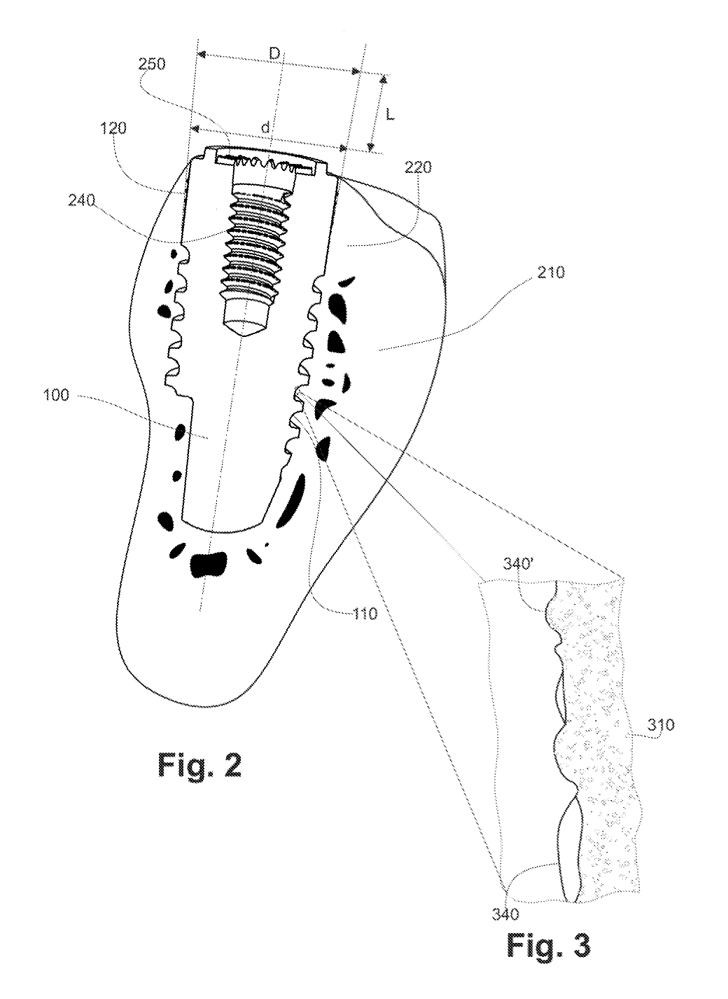

FIG. 2, according to an example of application of the implant of the invention, suitable for a periodontal implantation, the tapered screw micro-threading of the part (120) of the implant (100) implanted in the cortical bone (220), exhibits a conicity ranging between 0.02 and 0.1, which gives an angle at the tip of the cone ranging between 1.15° and 6°. The conicity is defined by the ratio (D-d)/L, i.e. the variation of the diameter measured at the thread crest over a given length L.

FIG. 3, the osseointegration is achieved by the colonization of the alveolar cavities (340) of the surface of the implant by the cells of the recipient tissue (310). Each alveolar cavity thus colonized (340′) being of a closed outline, constitutes, on an individual basis, a mechanical anchoring of the implant.

Coming back to FIG. 2, according to a particularly advantageous embodiment, the implant of the invention comprises an internal threading (240) and a fixture interface (250) suitable for receiving various suprastructures, such as a pillar, an abutment or a healing collar. Advantageously these suprastructures are also made of a sintered ceramic material, preferentially of quadratic yttria-stabilized zirconia. These suprastructures can advantageously comprise surface textures similar to the surface texture of the recipient tissue in which they are implanted.

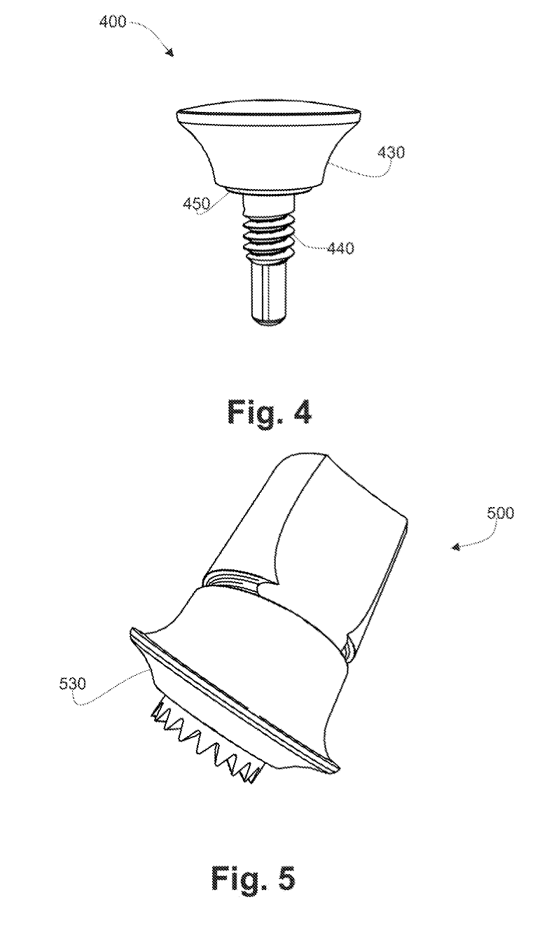

FIG. 4, according to an example embodiment, a healing collar (400) adaptable as a suprastructure on the body of the implant (100) comprises a threading (440), suitable for being screwed in the interior tapping (240) of the body of the implant, and a bearing surface (450), suitable for centering and abuting on the interface of fixture (250) of the aforesaid body of the implant (100). This healing collar is made of a sintered ceramic material and is produced according to the method according to the invention. It comprises a cicatrization surface (430) which is in contact with the gum after the set-up of this collar on the body of the implant (100) implanted in the bone tissue. Advantageously, this cicatrization surface comprises a surface texture similar to that of the gum tissue, similar to the external surface texture of the higher section (130) of the implant body. This surface texture promotes the cicatrization of the gum on the aforementioned cicatrization surface (430), allowing the later disassembling of this collar without bleeding.

FIG. 5, the abutment (500) allows the set-up of a crown. It has a bottom surface (530) which is embedded into the gum. This surface is of the same form as the cicatrization surface (430) of the healing collar (400). Advantageously, the surface (530) of the abutment comprises a surface texture similar to the texture of the gum tissue.

FIG. 6, the invention also relates to a method for the manufacturing of the body (100) or of a suprastructure (400, 500) of an endosseous implant made of zirconia.

According to an example embodiment, the method comprises a first step (610) consisting in obtaining a representation, hereafter qualified as the image of the wished surface texture, in particular an image of the texture of a tissue similar to that of the recipient tissue. It is not necessarily the image of the recipient tissue but of that of a tissue similar to this one.

This image can be a simple photography (601), it can also consist of a numerical file resulting from a three-dimensional scan of the texture of the tissue by any method known from the person skilled in the art. In a second step (620), a scale factor is applied to this image. This homothety, or scale factor, is a function of the shrinkage of the ceramic during sintering. Depending on the starting image, the homothety can be two-dimensional, for example in the case of a photograph, or three-dimensional, in the case of a topographic scan of the surface. The factor of shrinking of the ceramic at the time of sintering can reach 50%, depending on the nature of the ceramic used, and of its porosity content in the green state. Thus on the image (602) thus magnified, the surface outlined by the contour of an alveolar cavity is 2 to 2.5 times more important than surface on the initial image (601), and in the case of a three-dimensional image, the volume of an alveolar cavity is 3 to 3.5 times more important than its initial volume. The application of the factor of homothety can be carried out by a digital processing of the image (601) when this one is in the form of a data file, it can also be realized in an analogical way, for example by an enlarging of the photographic image (601). According to a later etching step (630), this homothetic image is etched on a wall of the imprint of the mould used for the realization of the implant by injection. This mould is preferentially made out of steel and the etching can be carried out by traditional techniques of photoengraving, or techniques of micromachining in particular by laser. The mould thus engraved is used for the injection (640) of a ceramic paste in order to make an implant in a green state, which is sintered, during a sintering step (650), in order to confer to this one its final properties. The pressure injection of the ceramic paste in the mould ensures the faithful reproduction of the form of the print including the surface textures. The minimal size of the surface patterns which can be reproduced depends on the grain size of the ceramic. The yttria stabilized zirconia is particularly favorable from this point of view, because its grain size is lower than 0.5 μm. In addition to its other advantageous properties, known from the prior art, this material makes it possible consequently to reproduce finest surface textures, like those of the cortical bone, so as to ensure an optimal osseointegration of the implant.

The foregoing description shows clearly that the invention achieved the pursued goals, in particular it allows an economic realization of a ceramic implant having a fine surface texture consisting of alveolar cavities with closed contour, which promotes the osseointegration of said implant in a recipient tissue.

1. An endosseous implant for an implantation in a periodontal tissue comprising an alveolar and a cortical bone tissues, the implant being made of a sintered ceramic material and comprising:
a first surface configured to be implanted in the alveolar bone tissue, the first surface comprising a surface texture made of patterns of recessed alveolar cavities with a closed outline whose average width lies between 8 μm and 15 μm and a surface finish of the surface texture lying between 1 μm and 3 μm, wherein the surface texture of the first surface replicates a surface texture of a tissue similar to the implantation alveolar bone tissue, and wherein the surface texture is printed on the first surface by molding before sintering; and
a second surface configured to be implanted in a cortical bone, the second surface comprising a surface texture comprising a pattern of recessed alveolar cavities with a closed outline whose width lies between 1.5 μm and 5 μm and a surface finish of the surface texture of the second surface lying between 0.1 μm and 0.5 μm, wherein the surface texture of the second surface replicates a surface texture of a tissue similar to the implantation cortical bone tissue, and wherein the surface texture is printed on the second surface by molding before sintering.

2. The implant according to claim 1, further comprising a cylindrical body; and
wherein the first surface is a threading comprising a cutting edge extending parallel to an axis of the cylindrical body so that said threading is self-tapping in the alveolar bone tissue.

3. The implant according to claim 1, further comprising a cylindrical body; and
wherein the second surface comprises a tapered screw thread.

4. The implant according to claim 3, wherein the tapered screw thread is interrupted at each turn.

5. An implant according to claim 4, wherein a surface of interruption of the tapered screw thread at each turn comprises a cutting edge.

6. The implant according to claim 4, wherein a conicity of the tapered screw thread of the second surface lies between 0.02 and 0.1.
